(19) United States
(12) Patent Application Publication
(10) Pub. No.: US 2021/0339112 A1
(43) Pub. Date: Nov. 4, 2021

(54) Electric Paddle Wheel Motorized Snowboard

(71) Applicant: Aaron Michael Rosenthal, Trabuco Canyon, CA (US)

(72) Inventor: Aaron Michael Rosenthal, Trabuco Canyon, CA (US)

(21) Appl. No.: 17/302,462

(22) Filed: May 4, 2021

Related U.S. Application Data
(60) Provisional application No. 63/019,783, filed on May 4, 2020.

(51) Int. Cl. A63C 5/08; B23P 19/04

(52) U.S. Cl. CPC A63C 5/085; A63C 5/03; B23P 19/04

(57) ABSTRACT

The subject invention provides a snowboard that is propelled over the snow by a battery powered hub motor. The preferred embodiments include a pair of elastic arms mounted in the tails section of the snowboard, on which specialized snow paddles are fitted to a hub motor designed for various snow conditions. The paddle wheel attaches to the elastic arms through axle locking plates transferring the trust provided by the hub motor to the snowboard.

### CROSS-REFERENCE TO RELATED APPLICATIONS

This application claims the benefit under 35 U.S.C. § 119(e) of U.S. Patent Application No. 63/019,783, entitled “An electrified paddle wheel mounted to a snowboard for propulsion.” filed May 4, 2020, which is incorporated herein by reference in its entirety.

### TECHNICAL FIELD

This disclosure relates to a system that allows a snowboarder to ride a snowboard with electrified paddle wheel propulsion.

### BACKGROUND

For decades snowboards have enjoyed snowboarding at ski resorts.

### BRIEF SUMMARY OF THE INVENTION

Unfortunately a hill is typically required to snowboard.

Unlike skiers who can rely on their own locomotion to move across snow-covered terrain. A snowboarder is strapped into bindings with both feet stuck to the snowboard. Snowboarders don't have any poles to provide additional traction.

This limits snowboarders to ski resort lifts and access to back country snow covered hills, and not the ability to use cross country trails and flat terrain as skiers can.

To overcome those shortcomings there have been numerous attempts to add power to a snowboard to not only allow a snowboard to move along level snow surfaces but to also move it along and up trails to those coveted backcountry spots. See, for example, U.S. Pat. Nos. 4,600,073; 4,984,648; 5,662,186; 6,698,540; 6,848,527; 7.434,644; 7,900,723; 7, 905,310; 8,091,671; 8,205,696; 8,844,664; and 8,991,541, as well as, International Publication Nos WO 2007/123469 and WO 2008/098541. However, these attempts to add power to snowboards have required that the board be truncated, use shocks, use track systems, gas engines or have cumbersome awkward modifications made to it, or alter the board so that the snowboarder no longer feels as if they are riding a traditional snowboard.

By interlocking paddles directly to an electric hub motor and mounting it between two elastic arms. We provide paddle based traction from the tail of the snowboard.

Like a steamboat paddles water.

This has many advantages over the previous attempts. This method allows maximum traction with very few parts. No shocks, No tracks. No metal mounting plates. Elastic arms are used to suspend the electric hub motor behind the snowboard with the hub motor mounted inside of the paddle wheel. This eliminates the need for shocks, or metal mounting hardware allowing the paddles to be compressed directly into the snow, moving up and down along uneven terrain.

Elastic arms are used to mount the hub motor and absorb the thrust provided by the paddles. In a way that the snowboarder is still able to free-ride, snowboarding like they normally do with minimal adverse side effects.

### BRIEF DESCRIPTION OF THE DRAWINGS

FIG. 1 is a schematic illustration of a snowboarder utilizing a paddle wheel mounted to a snowboard.

FIG. 2A is a top view schematic illustration of the tail section of the snowboard and paddle hub motor mounted to it.

FIG. 2B is an angled schematic illustration of the tail section of the snowboard and paddle hub motor.

FIG. 2C is a side view schematic illustration of the snowboard and paddle hub motor.

FIG. 3 is an exploded view of the paddle wheel and arms

FIG. 4A is an exploded angled view of the hub motor, paddles and paddle bolts.

FIG. 4B is an exploded rear view of the hub motor, paddles and paddle bolts.

FIG. 5 is an angled isolated view of elastic arm and axle lock.

FIG. 6 is an electrical diagram of the power system.

### DETAILED DESCRIPTION OF THE INVENTION

The subject invention provides a snowboard 001 that is propelled over the snow by an electric paddle 005 hub motor 004 wheel, mounted to the tail of snowboard 001 utilizing elastic arms 003 to compress the paddle wheel behind the snowboard 001. Said arms 003 attached directly to the snowboard 001 utilizing standard snowboard insert hardware 006. Said paddle wheel consists of an electric hub motor 004 with paddles 005 fitted directly to the hub motor 004 rotor. Paddle bolts 013 and nuts are used to fasten the paddles 005 to the hub motor 004. The elastic arms 003 use axle locks 007 fastened to the end of the arms 003 to lock the axle of the hub motor 004 in a fixed position. Axle lock bolts 016 are used to fasten the Axle locks 007 to the elastic arms 003.

Arm 003 elasticity and rebound is used to compress the paddles 005 attached to the hub motor 004 into the snow without the need of shocks or spring hardware, allowing the hub motor 004 to articulate according to varying terrain.

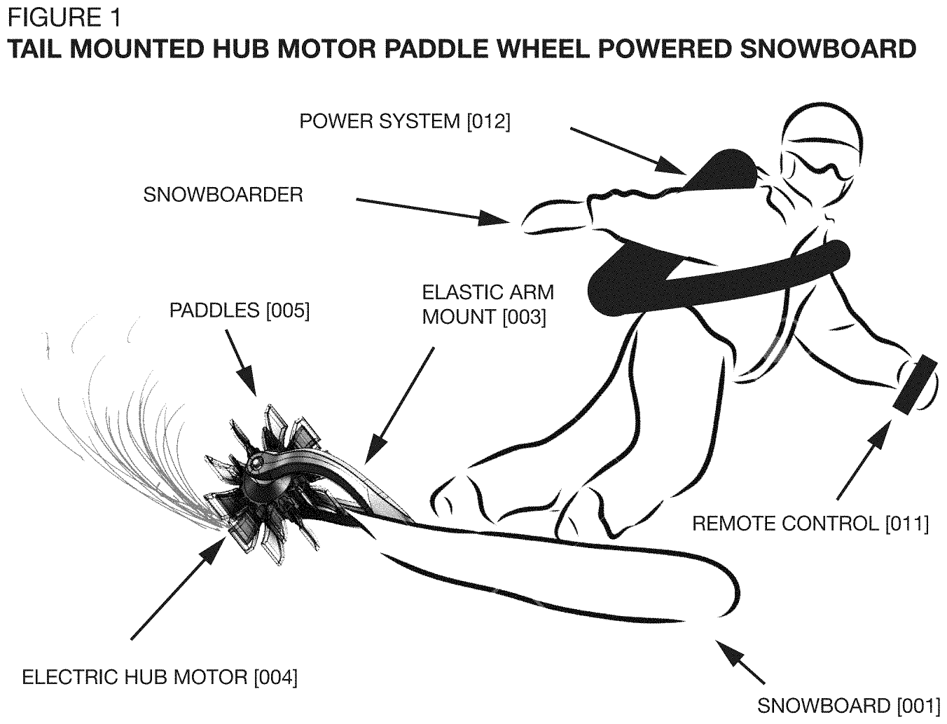

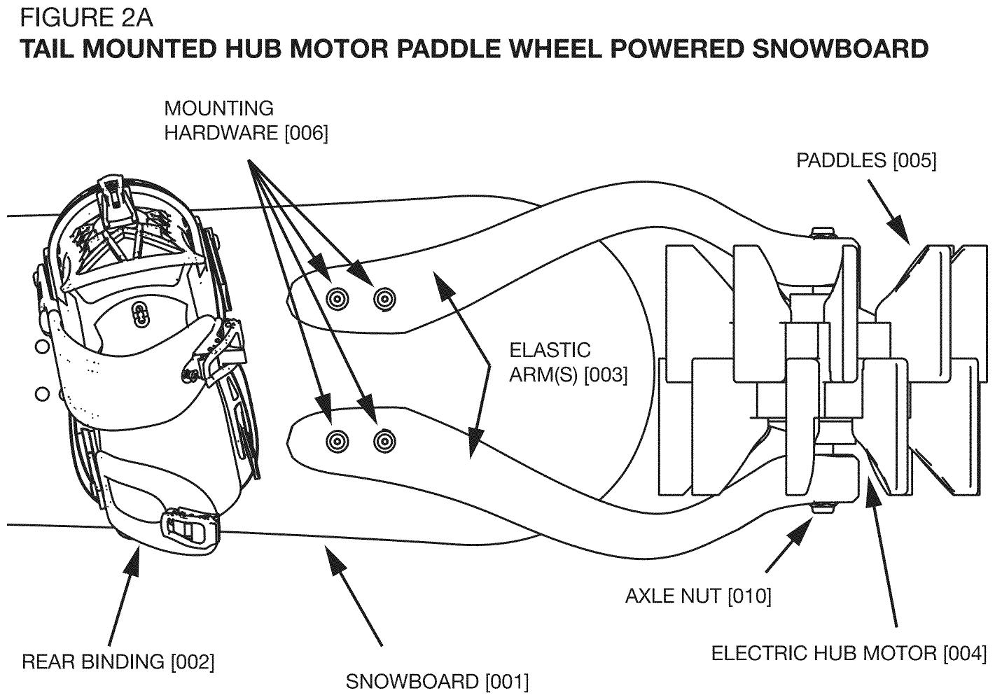

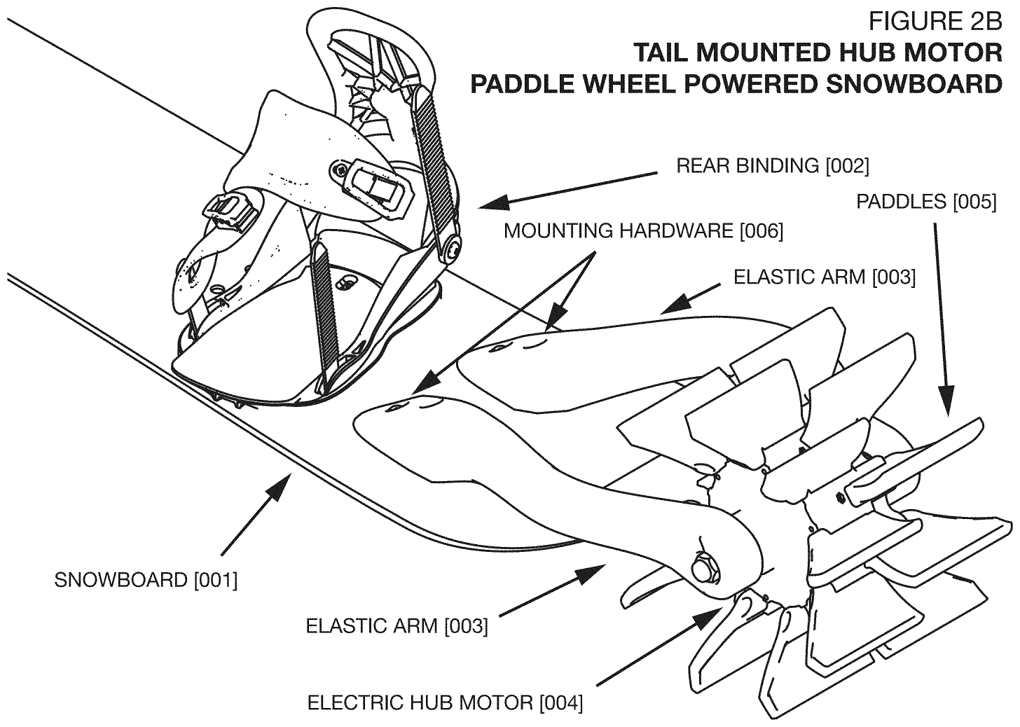

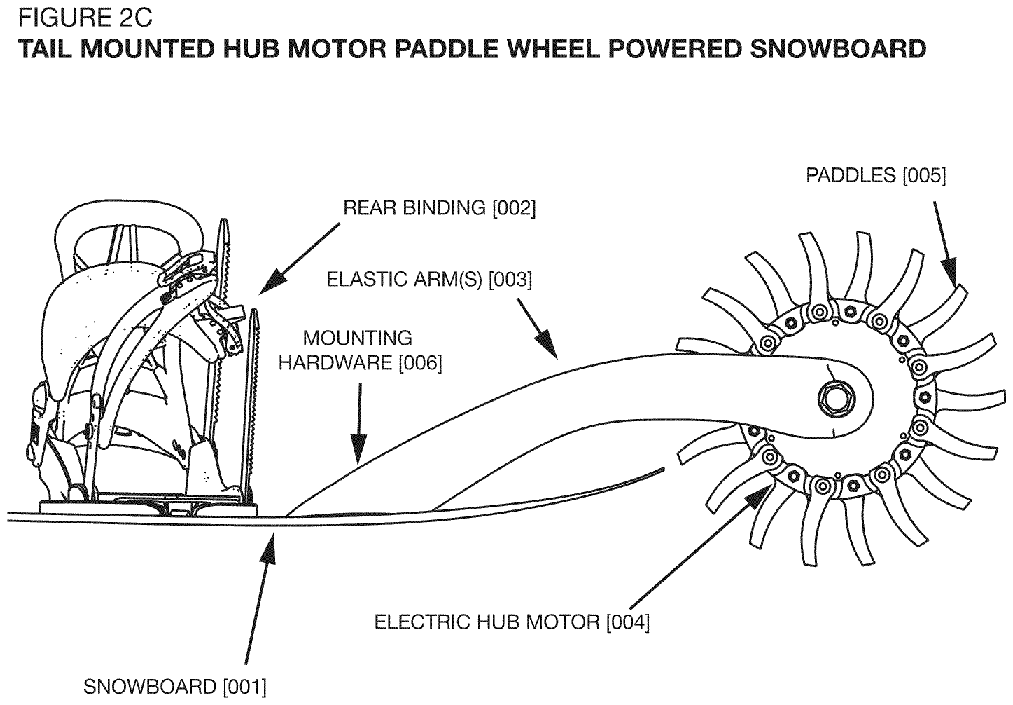

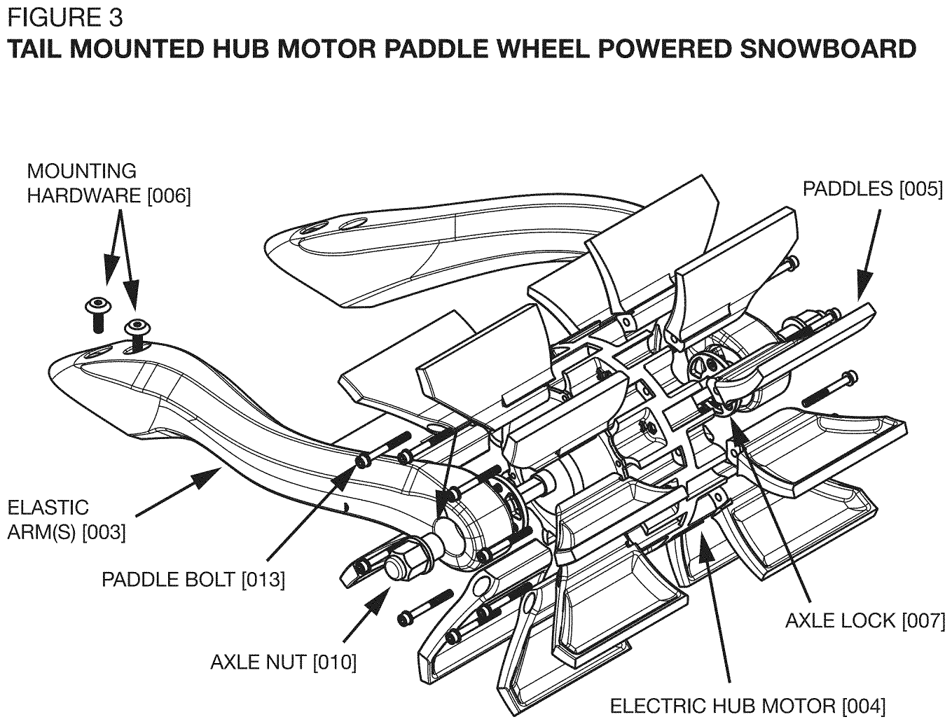

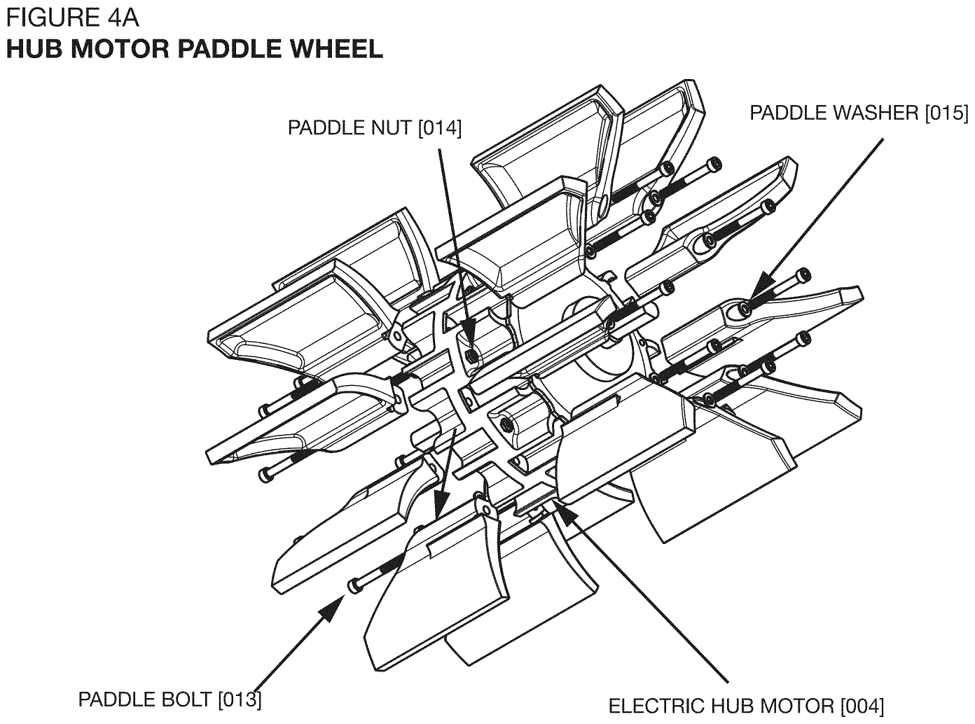

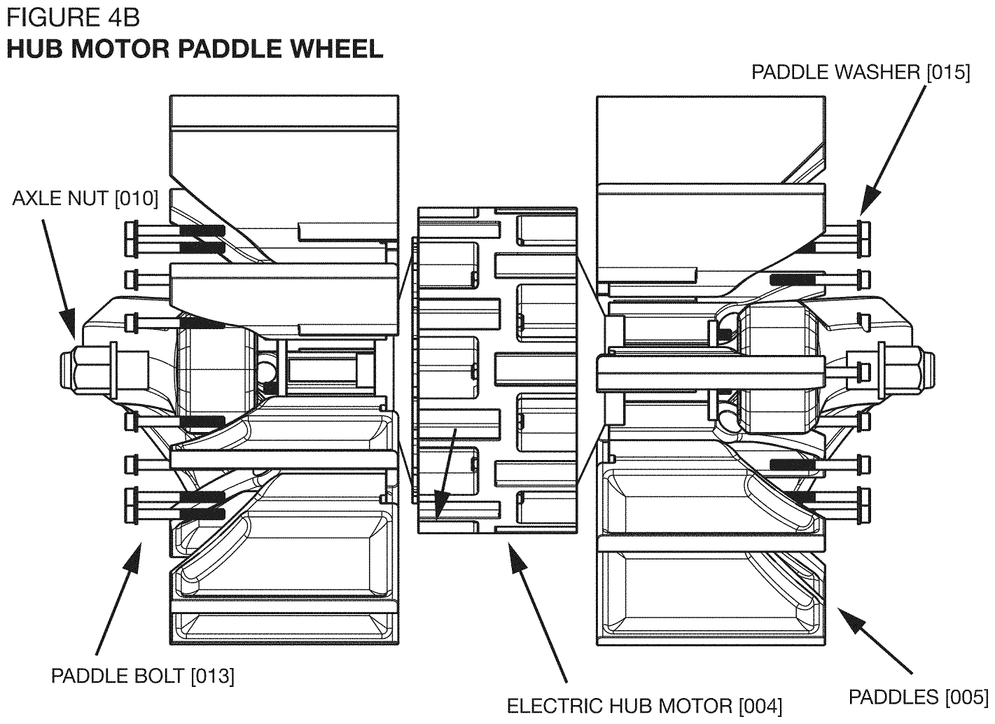

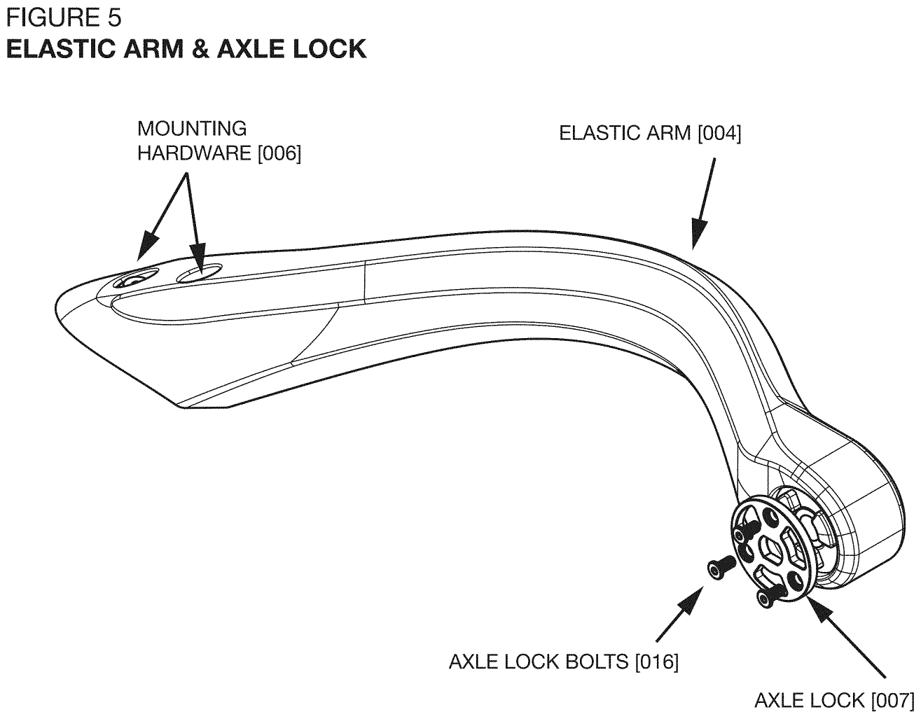

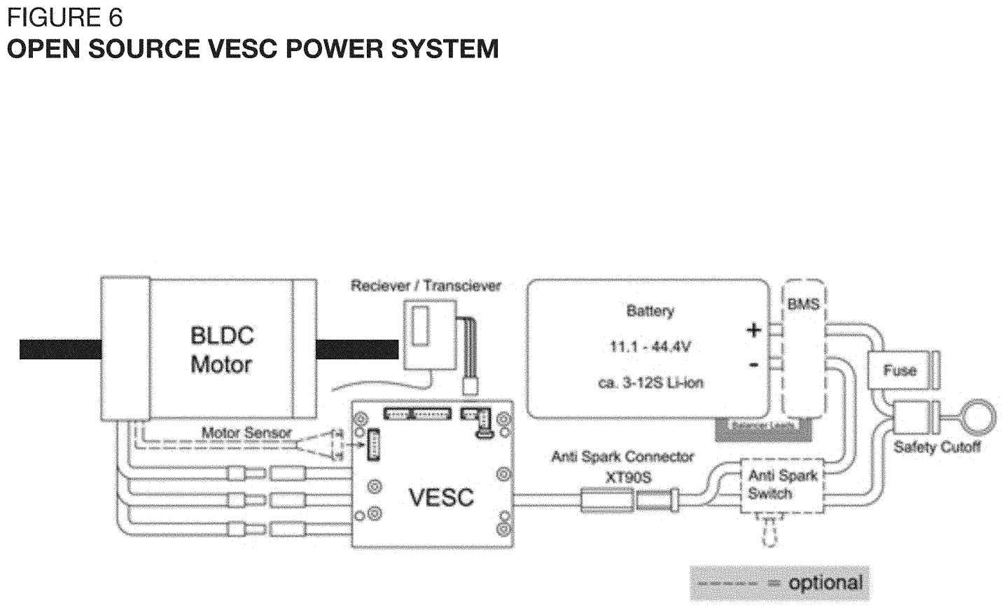

In a preferred embodiment as depicted in FIGS. 1-6, the subject invention has one pair of arms 003 mounted on the tail section of the snowboard 001 behind the rear binding 002. Such placement provides for minimal contact with the snowboard 001 allowing the snowboarder maximum control while riding.

Paddles 005 mounted directly to said hub motors rotor 004 allow a large surface area to make contact with the snow maximizing the motor power, while minimizing the diameter of the paddle wheel.

However, the number of paddles 005, size and style of paddle 005 may be altered pending snow and terrain conditions.

The hub motor 004 is powered by a power system 012 mounted on the snowboarder or on the snowboard 001 itself. The snowboarder controls the speed of the hub motor 004 using a hand based remote control 011.

Thus, particular embodiments of the subject matter have been described.

What is claimed is:

1. A method of mounting an electric hub motor behind a snowboard utilizing elastic arms.
a. Elastic arms that extend back to suspend an electric hub motor behind a snowboard.
b. Where said elastic arms include axle locks mounted to the arm. Locking the axle position of the hub motor between the elastic arms.

2. A method of mounting paddles of a paddle-wheel to an electric hub motor rotor.
a. Where said paddles are fitted directly to said electric hub motor rotor.
